(19) United States
(12) Patent Application Publication
(10) Pub. No.: US 2025/0106871 A1
(43) Pub. Date: Mar. 27, 2025

(54) SIDELINK FEEDBACK RESOURCE CONFIGURATION AND INDICATION, AND ASSOCIATED DEVICES AND METHODS

(71) Applicant: QUALCOMM Incorporated, San Diego, CA (US)

(72) Inventors: Chih-Hao LIU, San Diego, CA (US); Giovanni CHISCI, San Diego, CA (US); Xiaoxia ZHANG, San Diego, CA (US); Jing SUN, San Diego, CA (US)

(21) Appl. No.: 18/830,216

(22) Filed: Sep. 10, 2024

Related U.S. Application Data
(60) Provisional application No. 63/584,845, filed on Sep. 22, 2023.

(51) Int. Cl. H04W 72/25; H04W 72/0453

(52) U.S. Cl. CPC H04W 72/25; H04W 72/0453

(57) ABSTRACT

Devices, systems, and methods for configuring and indicating sidelink resources for shared or unlicensed frequency bands include configuring PSFCH resource sets using frequency interlaces of one or more PRBs. A first wireless communication device may transmit a plurality of sidelink PRB bitmaps, each associated with a PSFCH occasion or candidate. Each bit in the bitmap may indicate one PRB in the configured resource pool. The PSFCH resource sets may be partitioned by indexing the PRBs according to an interlace-first indexing sequence, and selecting contiguous subsets of indices to form the PSFCH resource sets.

### CROSS-REFERENCE TO RELATED APPLICATIONS

The present application claims the benefit of, and priority to, U.S. Provisional Patent Application No. 63/584,845, filed Sep. 22, 2023, the entirety of which is incorporated by reference herein.

### TECHNICAL FIELD

This application relates to wireless communication systems, and more particularly to improving sidelink communication with New Radio (NR) devices.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

Sidelink was introduced to allow a UE to send data to another UE without tunneling through the BS or an associated core network. Sidelink technology has been extended to provision for device-to-device (D2D) communications, vehicle-to-everything (V2X) communications, and cellular vehicle-to-everything (C-V2X) communications. Similarly, NR may be extended to support sidelink communications for D2D, V2X, or C-V2X over a dedicated spectrum, a licensed spectrum, or an unlicensed spectrum.

In existing systems, sidelink communications may include physical sidelink feedback channel (PSFCH) communications between UEs. These communications may be performed with each message comprising one or more resource blocks over one or more symbols. In some instances, PSFCH resources may be spread over a wider set of frequency resources to meet occupied bandwidth specifications. For example, PSFCH resources may be spread over wider sets of frequency resources in shared frequency bands or unlicensed frequency bands.

In some instances, multiple UEs may share portions of the unlicensed bands, which may complicate the configuration of PSFCH resources.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects of the present disclosure describe schemes and mechanisms for configuring and indicating sidelink feedback resources. In some instances, a UE may be configured to use portions of a same sidelink resource pool for PSFCH transmissions to provide ACK/NACK feedback. In some instances, a UE attempting to access unlicensed frequency resources (e.g., in a channel occupancy time (COT)) may not know precisely at what time the UE will be able to use the frequency resources. For instance, channel access procedures may vary in the amount of time based on the measurements the UE obtains. Accordingly, the UE may be configured with multiple successive PSFCH candidates or opportunities to allow for the UE to obtain PSFCH resources even with uncertainty regarding the timing at which the UE gains access to the unlicensed resources. It is desirable for the UE and network to use a PSFCH configuration mechanism that allows for this timing flexibility, and in particular when the multiple successive PSFCH candidates are not associated with the same sets of frequency resources.

The schemes and mechanisms described herein include one or more of generating, transmitting, receiving, or decoding bitmaps indicating PSFCH resource sets corresponding to the multiple PSFCH candidates. In one aspect, a UE may be configured to receive one bitmap for each PSFCH candidate of a plurality of PSFCH candidates, where the plurality of PSFCH candidates is associated with one or more of a same sidelink data or a sidelink control channel (e.g., physical sidelink shared channel (PSSCH), physical sidelink control channel (PSCCH), etc.). The bitmaps may be provided such that each bit of the bitmap is associated with one PRB in a sidelink resource pool. The plurality of bitmaps may indicate corresponding sets of PRBs, where each PRB set is non-overlapping with the PRB sets in the other bitmaps. Each PRB set may be associated with a respective PSFCH candidate.

In another aspect, each PRB set may be divided, segmented, or partitioned by indexing the PRBs according to an indexing sequence, and selecting contiguous subsets of indices to group the PRBs into the PSFCH resource sets. In an exemplary aspect, a network node, a UE, or any suitable wireless communication device may configure one or more PSFCH resource sets by first indexing the PRBs sequentially within a first frequency interlace of RBs, and then by indexing the PRBs sequentially in each of the other interlaces, also sequentially. The network node then partitions the indexed PRBs into PSFCH resource sets by grouping contiguous subsets of PRB indices.

In one aspect, a method of wireless communication performed by a first user equipment (UE) comprises: receiving a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; receiving a second PSFCH configuration including a second bitmap indicating, for a second PSFCH candidate, a second dedicated RB set, wherein the second dedicated RB set is non-overlapping in a frequency domain with the first dedicated RB set; and transmitting, based on a selection of one of the first PSFCH candidate or the second PSFCH candidate, a PSFCH signal.

In one aspect, a method of wireless communication performed by a network unit comprises: transmitting a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; transmitting a second PSFCH configuration including a second bitmap indicating, for a second PSFCH candidate, a second dedicated RB set, wherein the second dedicated RB set is non-overlapping in a frequency domain with the first dedicated RB set.

In one aspect, an apparatus comprises one or more memories; and one or more processors in communication with the one or more memories and configured to execute instructions on the one or more memories to cause the apparatus to: receive a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel; receive a second PSFCH configuration including a second bitmap indicating, for a second PSFCH candidate, a second dedicated RB set, wherein the second dedicated RB set is non-overlapping in a frequency domain with the first dedicated RB set; and transmit, based on a selection of one of the first PSFCH candidate or the second PSFCH candidate, a PSFCH signal.

In one aspect, an apparatus comprises one or more memories; and one or more processors in communication with the one or more memories and configured to execute instructions on the one or more memories to cause the apparatus to: transmit a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and transmit a second PSFCH configuration including a second bitmap indicating, for a second PSFCH candidate, a second dedicated RB set, wherein the second dedicated RB set is non-overlapping in a frequency domain with the first dedicated RB set.

In one aspect, a non-transitory, computer-readable medium has program code recorded thereon, wherein the program code comprises instructions executable by a processor of an apparatus to cause the apparatus to: receive a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; receive a second PSFCH configuration including a second bitmap indicating, for a second PSFCH candidate, a second dedicated RB set, wherein the second dedicated RB set is non-overlapping in a frequency domain with the first dedicated RB set; and transmit, based on a selection of one of the first PSFCH candidate or the second PSFCH candidate, a PSFCH signal.

In one aspect, a non-transitory, computer-readable medium has program code recorded thereon, wherein the program code comprises instructions executable by a processor of an apparatus to cause the apparatus to: transmit a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and transmit a second PSFCH configuration including a second bitmap indicating, for a second PSFCH candidate, a second dedicated RB set, wherein the second dedicated RB set is non-overlapping in a frequency domain with the first dedicated RB set.

In one aspect, a UE comprises: means for receiving a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; means for receiving a second PSFCH configuration including a second bitmap indicating, for a second PSFCH candidate, a second dedicated RB set, wherein the second dedicated RB set is non-overlapping in a frequency domain with the first dedicated RB set; and means for transmitting, based on a selection of one of the first PSFCH candidate or the second PSFCH candidate, a PSFCH signal.

In one aspect, a network unit comprises: means for transmitting a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and means for transmitting a second PSFCH configuration including a second bitmap indicating, for a second PSFCH candidate, a second dedicated RB set, wherein the second dedicated RB set is non-overlapping in a frequency domain with the first dedicated RB set.

Other aspects, features, and embodiments of the present invention will become apparent to those of ordinary skill in the art upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink feedback resource configuration scheme according to some aspects of the present disclosure.

FIG. 4A is a block diagram illustrating a sidelink communication scenario for communicating physical sidelink feedback channel (PSFCH) signals in an unlicensed frequency band according to some aspects of the present disclosure.

FIG. 4B is a block diagram illustrating a sidelink communication scenario for communicating PSFCH signals in an unlicensed frequency band according to some aspects of the present disclosure.

FIG. 4C is a block diagram illustrating a sidelink communication scenario for communicating PSFCH signals in an unlicensed frequency band according to some aspects of the present disclosure.

FIG. 5 is a block diagram illustrating a PSFCH configuration scheme according to some aspects of the present disclosure.

FIG. 6A is a block diagram illustrating exemplary PSFCH resource bitmaps according to some aspects of the present disclosure.

FIG. 6B is a block diagram illustrating exemplary PSFCH resource bitmaps according to some aspects of the present disclosure.

FIG. 7 is a hardware diagram illustrating a UE according to some aspects of the present disclosure.

FIG. 8 is a hardware diagram illustrating a network unit according to some aspects of the present disclosure.

FIG. 9 is a flow diagram of a method of sidelink communication according to some aspects of the present disclosure.

FIG. 10 is a flow diagram of a method of sidelink communication according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 400 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, as instructions stored on a computer readable medium for execution on a processor or computer, or a combination thereof. Furthermore, an aspect may comprise at least one element of a claim.

Sidelink communications refers to the communications among user equipment devices (UEs) without tunneling through a base station (BS) or a core network (e.g., via a PC5 link instead). Sidelink communication can be communicated over a physical sidelink control channel (PSCCH), a physical sidelink shared channel (PSSCH), a physical sidelink feedback channel (PSFCH), etc. The PSCCH is analogous to a physical downlink control channel (PDCCH) and the PSSCH to a physical downlink shared channel (PDSCH) in downlink (DL) communication between a BS and a UE.

As used herein, the term “sidelink UE” can refer to a user equipment device performing a device-to-device communication or other types of communications with another user equipment device independent of any tunneling through the BS (e.g., gNB) or an associated core network. As used herein, the terms “sidelink transmitting UE” and “transmitting UE” can refer to a user equipment device performing a sidelink transmission operation. As used herein, the terms “sidelink receiving UE” and “receiving UE” can refer to a user equipment device performing a sidelink reception operation.

It may be desirable to meet occupied channel bandwidth (OCB) specifications to reduce the amount of interference with adjacent channels. One mechanism to reduce interference is using frequency spreading techniques to spread a signal over a set of frequency resources dispersed over a wider band. For instance, frequency interlacing may be used to spread a signal and meet OCB specifications. Frequency interlacing may include or involve configuring resources for a signal (e.g., PSFCH) using interlaced sets of physical resource blocks (PRBs), or “interlaces,” in a configured resource pool. The PRBs in each interlace are spaced apart from one another by at least one other PRB associated with a different frequency interlace. For example, a sidelink resource pool may include 50 contiguous PRBs. The sidelink resource pool may be configured with 5 PRB interlaces, each interlace having 10 PRBs. Thus, for PRBs indexed continuously in the resource pool as 0, 1, 2, 3, 4, 5, 6, . . . 47, 48, 49, a first frequency interlace may include the PRBs indexed 0, 5, 10, 15, . . . 45. A second frequency interlace may include the PRBs indexed 1, 6, 11, 16, . . . , 46, and so on.

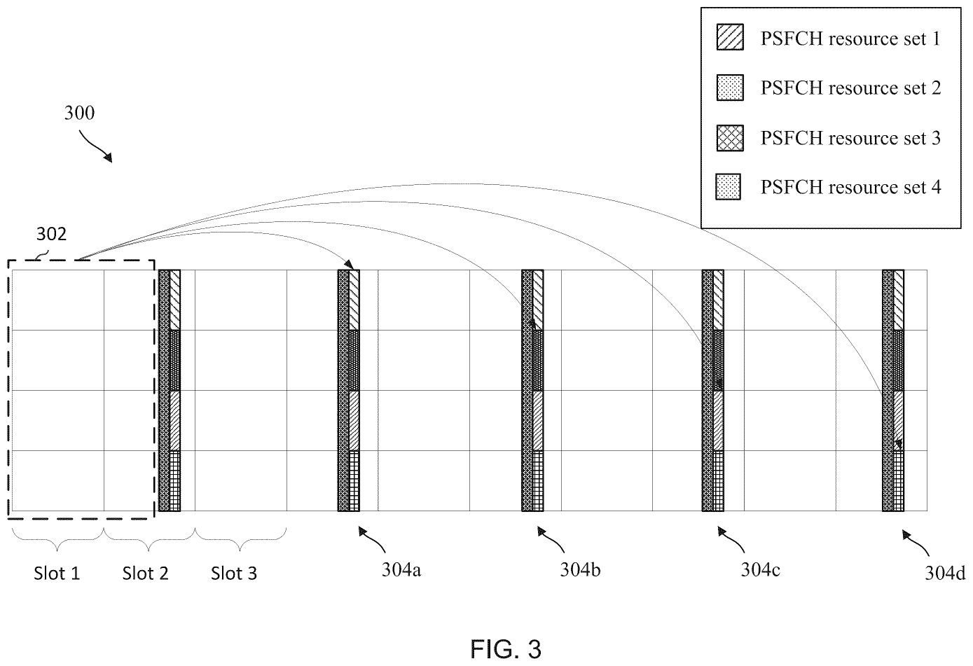

In some aspects, more than one UE may share the same sidelink resource pool. For instance, a plurality of UEs may be configured to use portions of the resource pool for PSFCH transmissions to provide ACK/NACK for PSCCH or PSSCH communications. As explained further below with respect to FIG. 3, it may also be desirable or advantageous to configure a UE with multiple successive PSFCH candidates or opportunities. In this regard, because a UE may perform a channel access procedure (e.g., listen before talk (LBT)) before gaining access to the sidelink resource pool, there may be uncertainty about the point in time at which the UE may be able to provide a PSFCH transmission. By configuring multiple opportunities, or PSFCH candidates, in the time domain, the UE may have a greater chance of being able to transmit PSFCH for sidelink communications. Further, it may also be beneficial for the UE to use a different subset of PRBs in the resource pool for each successive PSFCH candidate. In this regard, the resource pool may be divided or partitioned into a plurality of PSFCH resource sets, where the UE is configured to use a different PSFCH resource set in each of the PSFCH candidates or opportunities (see FIG. 3).

As a person of skill in the art will understand, there are many variables and parameters involved with configuring PSFCH resources-especially when multiple UEs share a resource pool, and the UE is using interlacing or some other frequency spreading technique to meet OCB specifications. Further, the size of the resource pool may depend on the subcarrier spacing (SCS) in a given frequency band. Some shared frequency bands may be associated with a SCS of 15 kHz, while other shared frequency bands may be associated with a SCS of 30 kHz. In some aspects, one or more of the number of PRBs in a resource pool, the number of interlaces used, or the number of PSFCH candidates, may vary with SCS and other parameters.

Aspects of the present disclosure describe schemes and mechanisms for configuring and indicating sidelink resources for shared or unlicensed frequency bands. Some aspects of the disclosure include configuring PSFCH resource sets using frequency interlaces of one or more PRBs. The PSFCH resource sets may be divided, segmented, or partitioned by indexing the PRBs according to an indexing sequence, and selecting contiguous subsets of indices to group the PRBs into the PSFCH resource sets. In an exemplary aspect, a network node, a UE, or any suitable wireless communication device may configure one or more PSFCH resource sets by first indexing the PRBs sequentially within a first frequency interlace, and then by indexing the PRBs sequentially in each of the other interlaces, also sequentially. The network node then partitions the indexed PRBs into PSFCH resource sets by grouping contiguous subsets of PRB indices.

Other aspects of the present disclosure describe schemes and mechanisms for indicating PSFCH configurations. In some aspects, a first wireless communication device may configure PSFCH resource sets for one or more PSFCH occasion using one or more sidelink PRB bitmaps. In one aspect, the first wireless communication device may transmit a plurality of sidelink PRB bitmaps, where each bitmap is associated with a different PSFCH occasion (also called PSFCH candidate). Each bit in the bitmap may indicate one PRB or a group including a plurality of PRBs in the configured resource pool. For instance, if the resource pool comprises 50 PRBs, the bitmap may include at least 50 bits, where each bit is associated with a different PRB in the resource pool.

In another aspect, the ordering or sequence of the bits in the bitmap may be based on, or otherwise associated with, the PRB sequential indexing scheme explained above. For instance, rather than the PRBs indexed sequentially based on their absolute position in the frequency domain, the PRBs may be indexed first within an interlace, and second across interlaces.

The mechanisms described above offer several advantages. By changing the PRB indexing procedure to an interlace-first approach, there are fewer potentially invalid PSFCH resource configurations that would otherwise result in an error, greater latency, and wasted power and network resources. Further, the interlace-first indexing approach may increase the efficiency in how the PRBs in the resource pool are used and distributed, thereby further decreasing latency. The bitmap PSFCH resource indication scheme provides for flexible and adaptable PSFCH resource set indication, which is particularly beneficial in unlicensed frequency bands with multiple devices sharing the frequency resources. This approach allows flexibility for UE implementation and dynamically updating resource configurations based on channel conditions. In summary, these changes can reduce latency and power consumption, thereby improving the user experience.

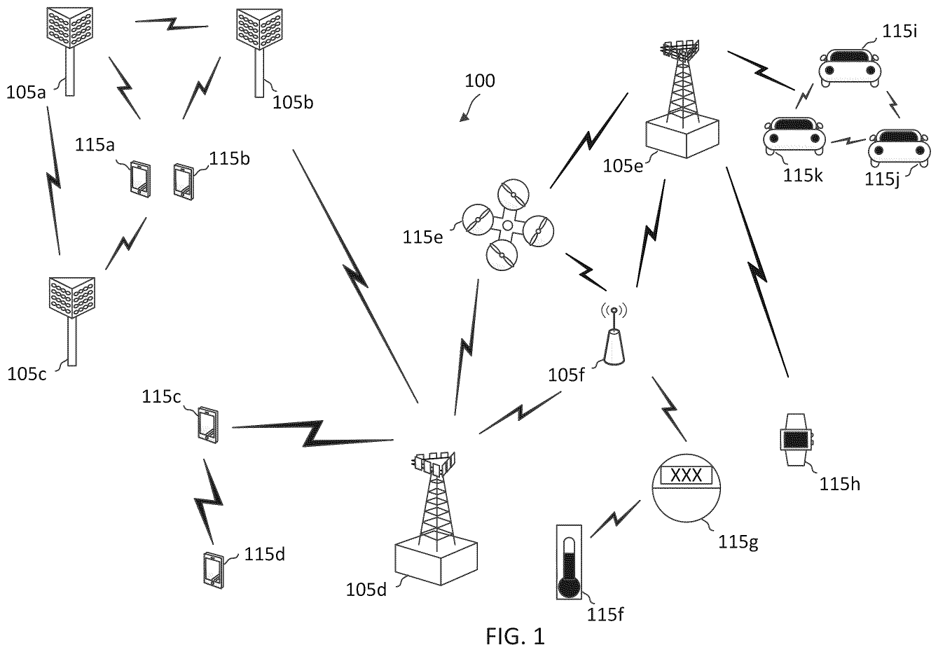

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may more generally be considered a network device. Each BS 105 may provide communication coverage for a particular geographic area. In 3GPP, the term “cell” can refer to this particular geographic coverage area of a BS 105 or a BS subsystem serving the coverage area, depending on the context in which the term is used.

A BS 105 may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and uplink (UL), desired transmission between BSs 105, backhaul transmissions between BSs, or sidelink transmissions between UEs 115 (such as and including according to embodiments of the present disclosure).

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as with small cells, such as the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, or vehicle-to-infrastructure (V21) communications between a UE 115i, 115j, or 115k and a BS 105 (e.g., PC5 etc.).

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands (i.e., sub-channels). In other instances, one or more of the subcarrier spacing (SCS) or the duration of TTIs may be scalable.

Both LTE and NR UEs 115 coexist in network 100. In this discussion, NR devices includes devices that are capable of both NR and LTE communication, and generally LTE devices are only capable of LTE communication. LTE generally uses a subcarrier spacing (SCS) of 15 kHz. For NR, SCS is configurable (e.g., either 15 kHz, 30 kHz, or 60 kHz), although typically uses a 30 kHz SCS. OFDM transmission schemes allow for signals of a single SCS to be orthogonal to each other, but with adjacent resources using different SCS values, signals nearby in frequency to each other may cause excessive interference. For example, a sub-channel for LTE communication using a 15 kHz SCS adjacent to an NR sub-channel using a 30 kHz SCS would result in the NR signals interfering with the LTE signals. Especially in circumstances where the power level of the NR signals is higher relative to the LTE signals, the signal to noise ratio may be decreased substantially.

In some aspects, the BSs 105 can assign or schedule transmission resources (e.g., in the form of time-frequency resource elements (RE)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data, operational data, or both. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., a PSS and a SSS) in the network 100 to facilitate synchronization. The BSs 105 can broadcast system information associated with the network 100 (e.g., including a master information block (MIB), remaining minimum system information (e.g., RMSI), and other system information (OSI)) to facilitate initial network access. In some instances, the BSs 105 may broadcast one or more of the PSS, the SSS, or the MIB in the form of synchronization signal block (SSBs) over a physical broadcast channel (PBCH) and may broadcast one or more of the RMSI or the OSI over a physical downlink shared channel (e.g., PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and OSI. After decoding the MIB, the UE 115 may receive RMSI and OSI. The RMSI and OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include one or more of a detected random access preamble identifier (ID) corresponding to the random access preamble, timing advance (TA) information, a UL grant, a temporary cell-radio network temporary identifier (C-RNTI), or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and DL communications. The BS 105 may transmit UL and DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via one or more of a PUSCH or a PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-U network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as COT (e.g., a channel occupancy time). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

In some aspects, the network 100 may support stand-alone sidelink communication among the UEs 115 over a shared radio frequency band. NR supports multiple modes of radio resource allocations (RRA), including a mode-1 RRA and a mode-2 RRA, for sidelink over a licensed spectrum. The mode-1 RRA supports network controlled RRA that can be used for in-coverage sidelink communication. For this mode, there is significant base station involvement and is typically operable when the sidelink UE 115 is within the coverage area of the serving BS 105, but not necessarily for out-of-coverage sidelink scenarios. The mode-2 RRA supports autonomous RRA that can be used for out-of-coverage sidelink UEs 115 or partial-coverage sidelink UEs 115.

Alternatively, a stand-alone system may include a sidelink UE 115 designated as an anchor UE (e.g., an anchor node). The anchor UE 115 may initiate sidelink operations with one or more client UEs 115 autonomously (e.g., independent of any cell or associated core network). Accordingly, the anchor UE 115 may announce system parameters (e.g., information associated with a sidelink master information block (SL-MIB), remaining minimum system information (RMSI), primary synchronization signal (PSS), secondary synchronization signal (SSS), etc.) for the operation of each of the client UEs 115, and the anchor UE 115 may provide respective radio resource control (RRC) configurations for corresponding client UEs 115. For example, the anchor UE 115 may provide first RRC configurations to a first client UE 115 and different second RRC configurations to a second client UE 115. Moreover, while the anchor UE 115 may interface with the client UEs using mode-1 RRA or mode-2 RRA, the signaling received by the client UEs 115 may remain the same between the two modes.

Sidelink UEs 115 (e.g., UEs 115 and 115d in FIG. 1, or UEs 115f and 115g) may perform aspects of methods described herein, including configuring and indicating PSFCH resource sets.

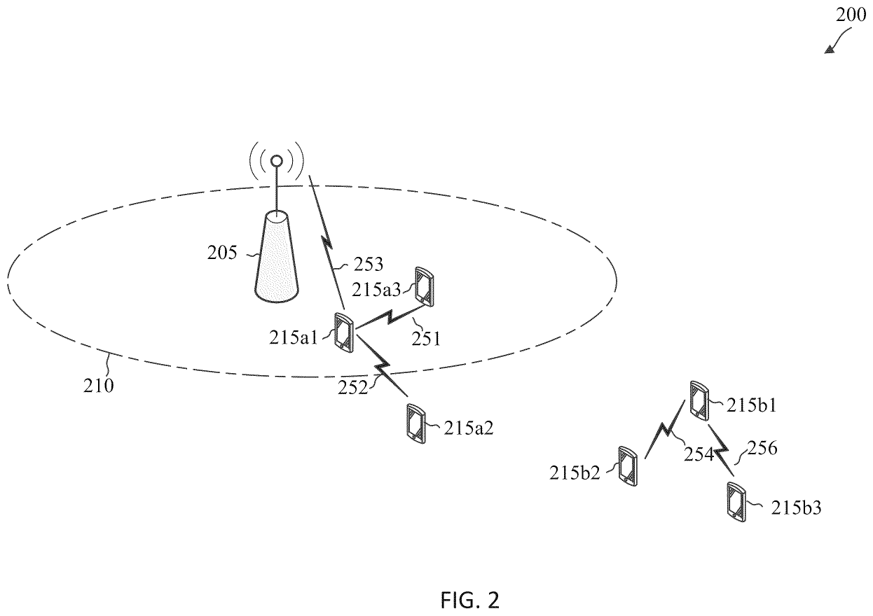

FIG. 2 illustrates an example of a wireless communication network 200 that provisions for sidelink communications according to aspects of the present disclosure. The network 200 may correspond to at least a portion of the network 100. FIG. 2 illustrates a BS 205 and six UEs 215 (shown as 215a1, 215a2, 215a3, 215b1, 215b2, and 215b3) for purposes of simplicity of discussion, though it will be recognized that aspects of the present disclosure may scale to any suitable number of UEs 215 and BSs 205. The BS 205 and the UEs 215 may be similar to the BSs 105 and the UEs 115, respectively. The BSs 205 and the UEs 215 may share the same radio frequency band (or at least a sub-band thereof) for communications. In some instances, the radio frequency band may be a 2.4 GHz unlicensed band, a 5 GHz unlicensed band, or a 6 GHz unlicensed band (or some other band, such as FR2). In general, the shared radio frequency band may be at any suitable frequency.

The BS 205 and the UEs 215a1-215a3 may be operated by a first network operating entity. The UEs 215b1-215b3 may be operated by a second network operating entity. In some aspects, the first network operating entity may utilize a same RAT as the second network operating entity. For instance, the BS 205 and the UEs 215a1-215a3 of the first network operating entity and the UEs 215b1-215b3 of the second network operating entity are NR-U devices. In some other aspects, the first network operating entity may utilize a different RAT than the second network operating entity. For instance, the BS 205 and the UEs 215a1-215a3 of the first network operating entity may utilize NR-U technology while the UEs 215b1-215b3 of the second network operating entity may utilize WiFi or LAA technology.

In the network 200, some of the UEs 215a1-215a3 or UEs 215b1-215b3 may communicate with each other in peer-to-peer communications. For example, the UE 215al may communicate with the UE 215a2 over a sidelink 252, the UE 215al may communicate with the UE 215a3 over another sidelink 251, the UE 215b1 may communicate with the UE 215b2 over yet another sidelink 254, and the UE 215b1 may communicate with the UE 215b3 over sidelink 256. The sidelinks 251, 252, 254, and 256 may be unicast bidirectional links. Some of the UEs 215 may also communicate with the BS 205 in a UL direction and a DL direction via communication links 253. For instance, the UE 215al and 215a3 are within a coverage area 210 of the BS 205, and thus may be in communication with the BS 205. The UE 215a2 is outside the coverage area 210, and thus may not be in direct communication with the BS 205. In some instances, the UE 215al may operate as a relay for the UE 215a2 to reach the BS 205. As an example, some of the UEs 215 may be associated with vehicles (e.g., similar to the UEs 115i-k) and the communications over the sidelinks 251, 252, 254, and 256 may be C-V2X communications. C-V2X communications may refer to communications between vehicles and any other wireless communication devices in a cellular network. This is exemplary only, as the sidelinks may be between any of a variety of different UE types and communications.

Similar to network 100 of FIG. 1, the network 200 may support sidelink communication among the UEs 215, including one or more modes supported by a BS 205, and one or more stand-alone modes that do not require BS 205 support. As part of the sidelink communication, a sidelink UE, such as 215b1 (as just one example), may transmit sidelink messages to another UE 215 according to methods described herein.

FIG. 3 illustrates a sidelink feedback resource configuration scheme 300 according to some aspects of the present disclosure. The scheme 300 may be employed by UEs such as the UEs 115 and 215 in a network such as the networks 100 and 200. In particular, sidelink UEs may employ the scheme 300 to engage in sidelink communications over a shared radio frequency band (e.g., in a shared spectrum or an unlicensed spectrum), including PSFCH messaging according to aspects of the present disclosure.

In scheme 300, a grid is illustrated representing a sidelink resource pool configured for one or more sidelink UEs over a period of time. In the grid, the x-axis represents time in some arbitrary units. Each white box in the x-axis may represent one slot, including slot 1, slot 2, slot 3, etc. However, it will be understood that, in other aspects, each white box may represent some other unit of time, such as one subframe, one frame, or any other suitable amount of time (e.g., us, ms, mini-slot, etc.). In the y-axis, the frequency resources are grouped into four PRB resource sets. Each PRB resource set may comprise one or more PRBs. For the purpose of the present disclosure, PRBs may also be referred to more simply as “resource blocks” (RBs). In an exemplary embodiment, each PRB set comprises a plurality of RBs. The RBs of each PRB set may comprise a contiguous set of RBs in the frequency domain, or a non-contiguous set of RBs (e.g., interlaced RBs). An RB may comprise a number of consecutive subcarriers (e.g., 12 subcarriers) in the frequency domain and one or more symbols in the time domain.

A periodic PSFCH resource set is configured or otherwise associated with each of the PRB sets. For instance, PSFCH resource set 1 is associated with a first (uppermost) PRB set, PSFCH resource set 2 is associated with a second PRB set, PSFCH resource set 3 is associated with a third PRB set, and PSFCH resource set 4 is associated with a fourth (lowermost) PRB resource set. Each PSFCH resource set is periodic, and repeats once every other slot (or subframe, etc.). It will be understood that any suitable periodicity for the PSFCH resource sets may be configured, including every slot, every other slot, every three slots, every four slots, every eight slots, every frame, etc.

The periodic occurrences of the PSFCH resource sets may be referred to as a PSFCH occasion 304, including PSFCH occasions 304a-304d. Each PSFCH occasion 304 may be preceded by a gap period or guard symbol, as shown in FIG. 3. In the illustrated example, all of the PSFCH occasions 304a-304d are associated with a sidelink data channel 302. In some aspects, the sidelink data channel 302 may include a PSCCH. In other aspects, the sidelink data channel 302 may include a PSSCH. The PSFCH occasions 304a-304d are configured for a UE to provide sidelink feedback (e.g., ACK/NACK) for the sidelink data channel 302. As mentioned above, in unlicensed frequency bands, a UE transmitting PSFCH may first perform a listen-before-talk (LBT) procedure before gaining access to the frequency resources to transmit the PSFCH. Some LBT procedures have uncertain or variable durations, such as LBT procedures that include random backoff periods. Accordingly, due to the uncertainty in the time at which the UE will gain access to the sidelink resource pool, the multiple PSFCH occasions 304a-304d provide flexibility for the UE transmit PSFCH in case the first PSFCH occasion has passed before the UE successfully completes the LBT.

In some aspects, it may be beneficial or desirable to use a different subset of frequency resources in the sidelink resource pool for different PSFCH occasions. As illustrated in FIG. 3, for the sidelink data channel 302, the UE transmitting PSFCH may cycle through the PSFCH resource sets for successive PSFCH occasions. Thus, for a first PSFCH occasion 304a, the UE may transmit PSFCH using PSFCH resource set 1. For the second PSFCH occasion 304b, the UE may transmit PSFCH using PSFCH resource set 2, and so on. In some aspects, this approach allows the UE to transmit sidelink feedback for different sidelink data channels (e.g., 302 and a second sidelink data channel occupying slot 3) in a single PSFCH occasion (e.g., PSFCH occasion 304b).

The PSFCH resource configuration for a UE may involve several variables parameters for transmitting a PSFCH waveform. These parameters include the PRB interlace index, the number of PRBs within the interlace that the PSFCH waveform occupies, the number of PSFCH occasions configured for each PSCCH transmission, each PSSCH transmission, or both, the number of PSFCH resource sets (or PRB resource sets), and how each PSCCH/PSSCH transmission is mapped to the different PSFCH resource sets. In some aspects, a UE may use a configured number of PRBs within one common interlace for a PSFCH transmission. A common interlace may be an interlace of PRBs that may be shared by multiple UEs for communications to and from the UEs. A dedicated interlace may be an interlace of PRBs that is allocated for a single UE, or for a subset of UEs. The configured number of PRBs may be denoted as K3. In some aspects, K3 may be configured using radio resource control (RRC) signaling, or may be a fixed or hard coded configuration. The configuration may vary based on the frequency band in which the sidelink resource pool is found, the SCS associated with the resource pool, UE capabilities, channel conditions, or other variables. The combination of configured parameters may result in a subset of RBs from the sidelink resource pool for a PSFCH transmission during a given PSFCH occasion.

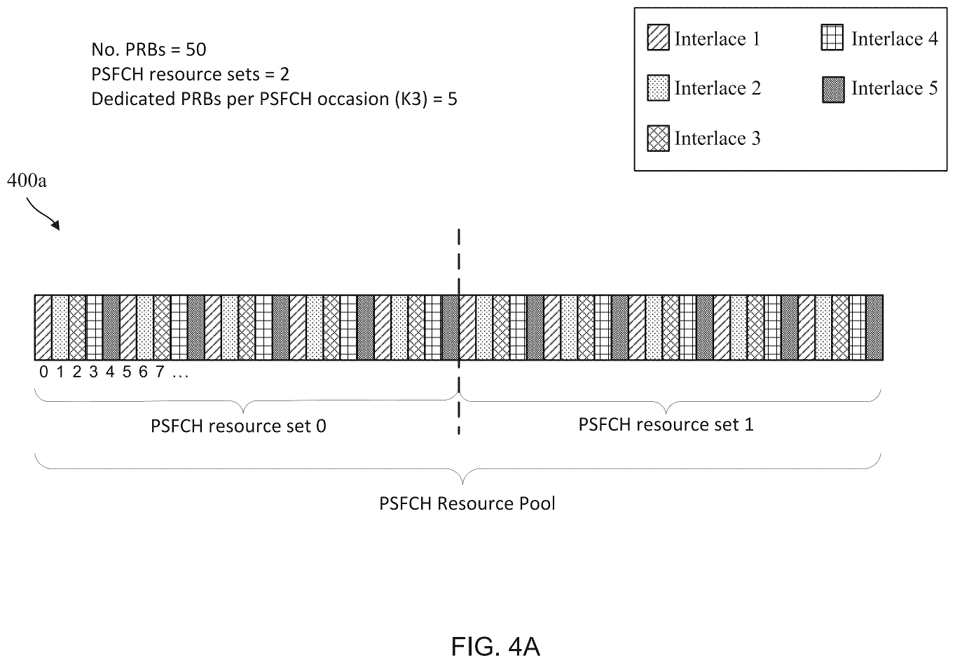

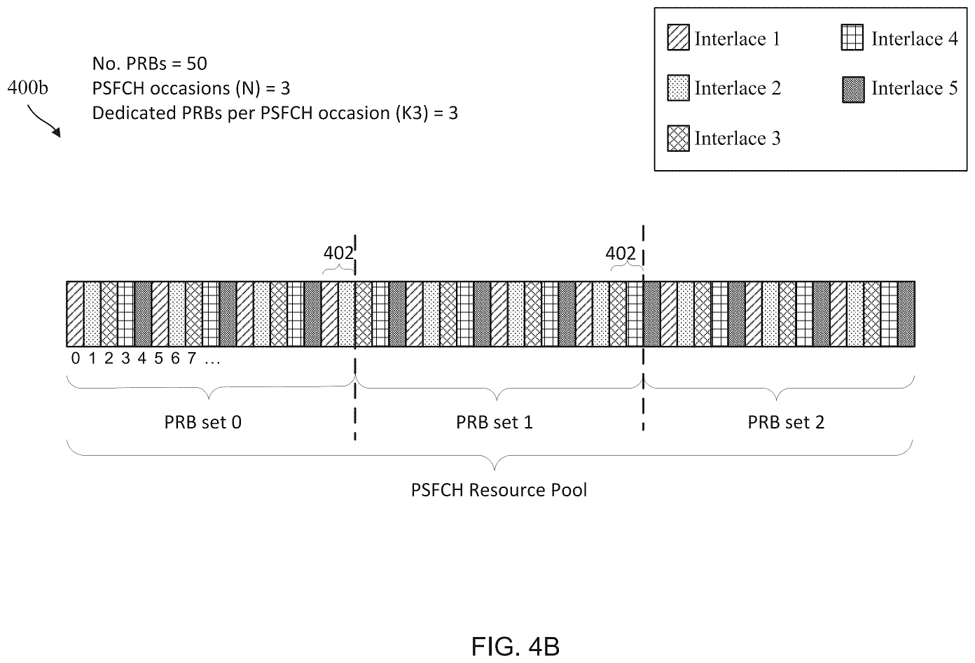

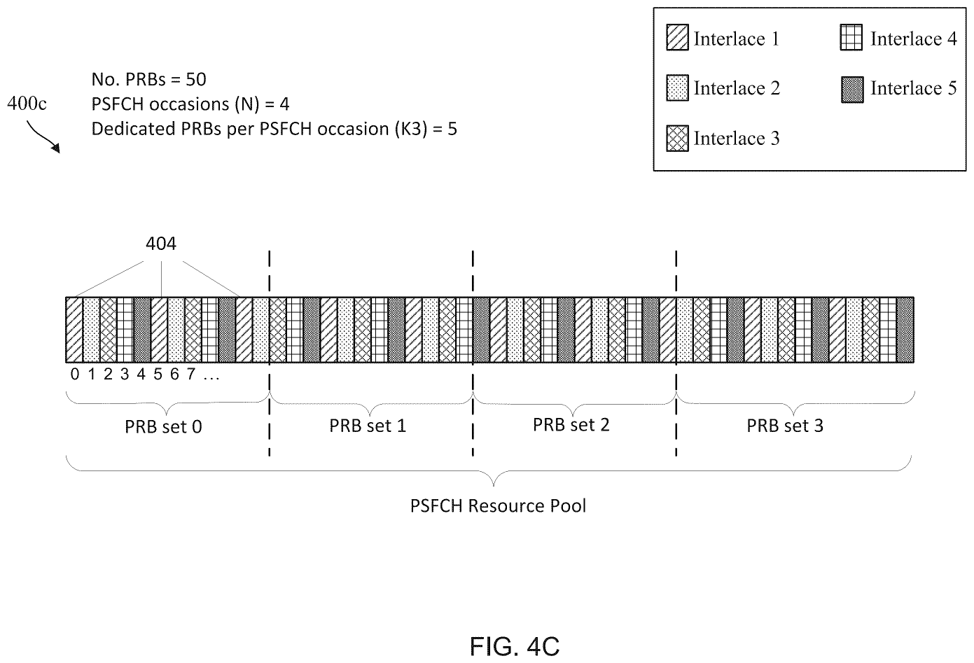

Due to the complex nature of PSFCH resource configurations, there is a possibility for faulty configurations. A faulty PSFCH resource configuration may involve a combination of dynamically configured, semi-statically configured, and statically-configured parameters that result in a UE not being able to transmit a PSFCH waveform that would satisfy the wireless specification or standards (e.g., 3GPP specifications). In this regard, FIGS. 4A, 4B, and 4C illustrate sidelink communication scenarios 400a-400c in which a UE is configured with a sidelink resource pool of 50 RBs in an unlicensed frequency band or a shared frequency band. In each scenario 400, the UE is configured with a set of parameters, including number of PSFCH resource sets (N), and a number of dedicated PRBs in an interlace for a PSFCH transmission (K3). In some aspects, the number (N) of PSFCH resource sets may correspond to the number of PSFCH occasions configured for a given PSCCH/PSSCH communication.

Referring to the scenario 400a in FIG. 4A, the UE is configured with 2 PSFCH resource sets (N=2), and 5 dedicated PRBs for each PSFCH transmission (K3=5). The UE is also configured with five interlaces, which each interlace using 10 PRBs in the 50 PRB resource pool. The PRBs are indexed (0, 1, 2, 3, 4, 5, 6, 7, . . . ) sequentially based on their frequency location within the resource pool. Thus, interlace 1 includes the PRBs indexed 0, 5, 10, 15, 20, . . . , 40, and 45. Interlace 2 includes the PRBs indexed 1, 6, 11, 16, 21, . . . , 41, and 46, etc. The PRBs are grouped, partitioned, or segmented into two PSFCH resource sets, each comprising a contiguous block of 25 PRBs. As shown, each of the two PSFCH resource sets includes five PRBs in each of the five interlaces. Thus, for any given interlace, there will be five PRBs that can be used for a PSFCH transmission. Accordingly, the scenario 400a in FIG. 4A may be a valid PSFCH resource configuration, since the configured number of PRBs for a PSFCH transmission (K3) is 5. Further, this PSFCH resource configuration may efficiently use the provided resources whereby all of the dedicated PRBs in an interlace and in one PSFCH resource set are used.

However, different combinations of parameters may result in a suboptimal configuration in which one or more PRBs are unused or wasted. In the scenario 400b of FIG. 4B, the UE is configured with three PSFCH resource sets for 50 PRBs (N=3), and three dedicated PRBs for PSFCH transmission (K3=3). However, in each PSFCH resource set, there are at least some interlaces that have more than three PRBs. For example, in PSFCH resource set 0, interlace 1 and interlace 2 each have four PRBs. Thus, PSFCH transmissions in either of interlaces 1 or 2 in PSFCH resource set 0 may leave the last PRBs 402 unused. A similar issue exists for PRB set 1 with interlace 3 and 4.

Moreover, some combinations of parameters may result in a PSFCH resource configuration that is invalid. In the scenario 400c of FIG. 4C, the UE is configured with four PSFCH resource sets for 50 PRBS (N=4), and five dedicated PRBs for PSFCH transmission (K3=5). However, in this scenario, each PSFCH resource set has only two or three PRBs of each interlace. For instance, the number of PRBs 404 of the interlace 1 is only three for PSFCH resource set 0. There is no PSFCH resource set that has the configured number (K3-5) of PRBs for a PSFCH transmission for any interlace.

The present disclosure describes methods, schemes, and mechanisms for configuring PSFCH resource sets that addresses one or more of the issues described above. In one aspect, a PSFCH resource configuration scheme may involve sequentially indexing PRBs in a sidelink resource pool first within an interlace, and second across interlaces. For instance, the PSFCH resource configuration scheme may include assigning sequential indices to the PRBs within a first frequency interlace, followed by the PRBs within a second frequency interlace, followed by the PRBs within a third interlace, and so on. Once indexed, the PSFCH resource configuration scheme may include partitioning, segmenting, or otherwise grouping the indexed PRBs in the resource pool into resource sets, where each resource set comprises a contiguous subset of the PRB indices. In some aspects, the partitioning may result in PSFCH resource sets that are effectively partitioned based on the interlaces. For instance, a first PSFCH resource set may include all of the PRBs of interlace 1, a second PSFCH resource set may include all of the PRBs of interlace 2, etc. However, other combinations are also contemplated, including PSFCH resource sets that include only a portion (e.g., one half) of the PRBs within a first frequency interlace, PRBs of more than one interlace (e.g., all PRBs of interlace 1, half of the PRBs of interlace 2, etc.).

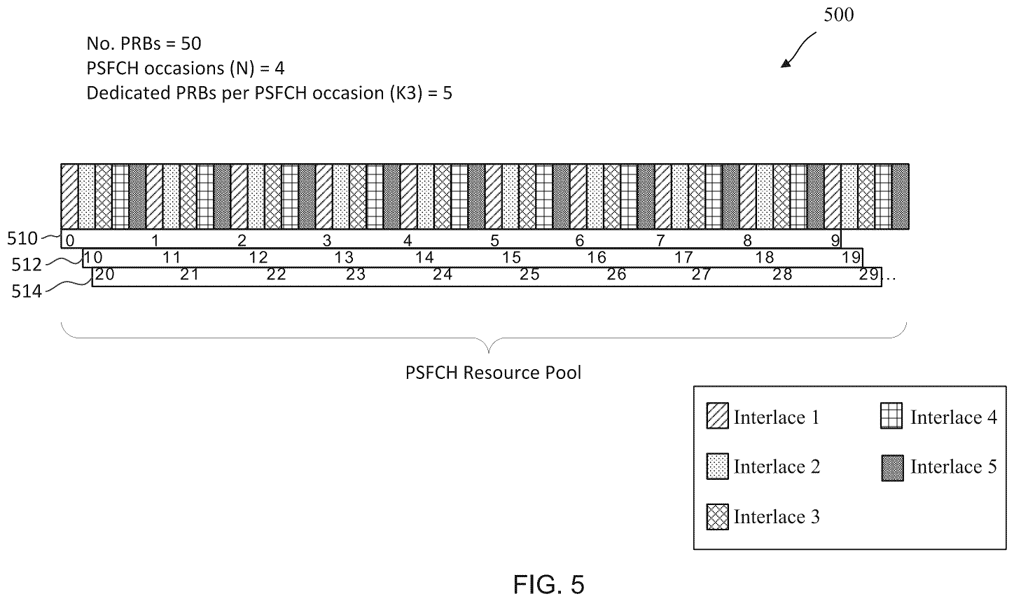

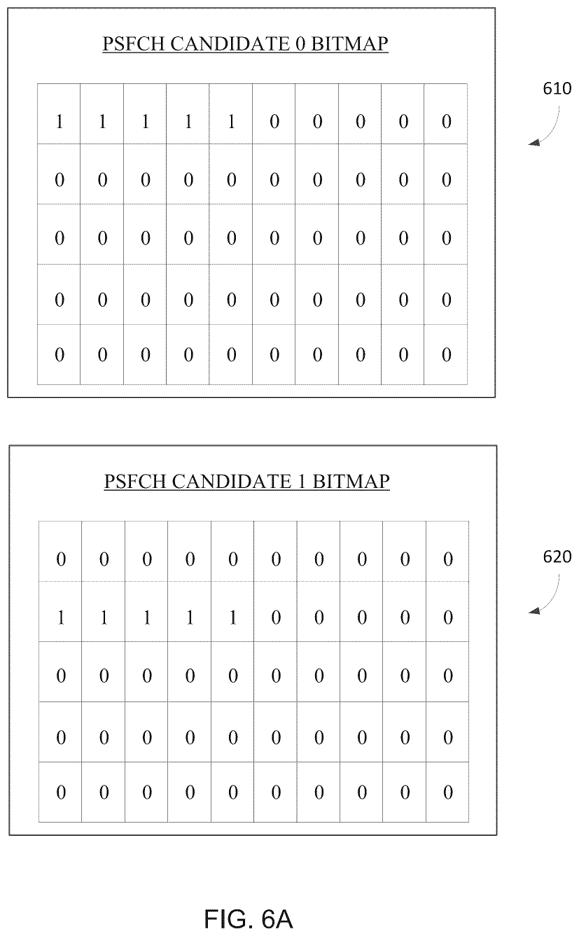

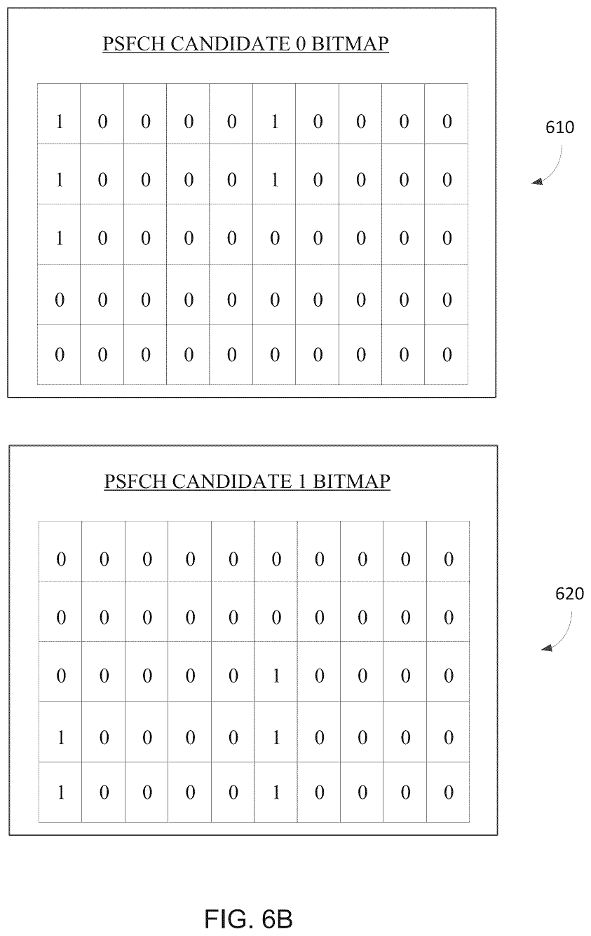

Referring to FIG. 5, a PSFCH resource configuration scheme 500 is shown with interlace-first indexing. Aspects of the scheme 500 may be performed by a UE, a network node, or both. For instance, one or more of a network node or a sidelink UE may use the scheme 500 shown below to generate a bitmap for configuring another UE with PSFCH resources. Exemplary aspects of the bitmap are shown in FIG. 6 and described further below. Additionally, a sidelink UE may receive one or more bitmaps, and determine, map, or otherwise identify the PSFCH resource sets based on the same interlace-first mapping scheme 500 shown in FIG. 5.

Similar to the scenarios 400a-400c, in the scheme 500, a sidelink resource pool includes 50 PRBs with five interlaces. A sidelink resource configuration, such as a PSFCH resource configuration, may indicate that there are four PSFCH occasions associated with each PSCCH/PSSCH transmission. Accordingly, the network node, the sidelink UE, or both, may be configured to partition, segment, or otherwise group the PRBs of the resource pool into four PSFCH resource sets. As explained above, simply dividing the PRBs into four groups of 12-14 PRBs may result in each of the PSFCH resource sets having less than five PRBs of each interlace. If the configured value for K3 is 5, as in the scheme 500, then none of the PSFCH resource sets would be valid for a PSFCH transmission.

Accordingly, in the scheme 500, the network node and the UE use an interlace-first indexing scheme whereby the PRBs are indexed within an interlace first, and across interlaces later. Thus, the PRBs associated with interlace 1, which has PRBs spaced every five PRBs in the resource pool, are indexed [0, 1, 2, 3, 4, 5, 6, 7, 8, 9]. The network node or the UE may then continue the sequential indexing with the PRBs of interlace 2. The PRBs of interlace 2, which also has PRBs spaced every five PRBs in the resource pool, are indexed [10, 11, 12, 13, 14, 15, 16, 17, 18, 19]. This process is repeated for each interlace. Based on the procedure described herein, a person of skill in the art would understand that the PRBs of interlace 5 would be indexed [40, 41, 42, 43, 44, 45, 46, 47, 48, 49].

Once all PRBs of the resource pool are indexed in this manner, the network node or the UE partitions, segments, or otherwise groups the PRBs based on their assigned indices. For instance, the network node or the UE may partition the PRBs into four contiguous blocks of PRBs based on their indices, such that the PRBs indexed 0-9 are partitioned into one PSFCH resource set 510, the PRBs indexed 10-19 are partitioned into a second PSFCH resource set 512, the PRBs indexed 20-29 are partitioned into a third PSFCH resource set 514, and so on. In this example, the partitioning effectively groups or segments the PRBs into PSFCH resource set based on their interlace index (e.g., interlace 1, interlace 2, etc.). In some aspects, one of the PSFCH resource sets may comprise more than 10 PRBs, including PRBs associated with more than one interlace. For example, the fourth PSFCH resource set may comprise all PRBs of interlace 4, and all PRBs of interlace 5, amounting to 20 PRBs in total. In other aspects, the network node or the UE may ignore or omit the PRBs of interlace 5 in the PSFCH resource sets, such that each of the four PSFCH resource sets comprises 10 PRBs associated with a same interlace. In other aspects, the network node or the UE may include PRBs of more than one interlace into a single PSFCH resource set. For instance, the UE may include all PRBs of interlace 1 into a first PSFCH resource set, and five of the PRBs of interlace 2 into a second PSFCH resource set.

It will be understood that the partitioning of PRBs into resource sets based on the interlace-first indexing scheme 500 is also based on the configured number of PSFCH occasions associated with a sidelink data transmission (e.g., PSCCH, PSSCH, etc.). Further, the partitioning will be based on the configured number of interlaces, and the number of PRBs in a sidelink resource pool. Thus, the specific scenario illustrated in FIG. 5 is only exemplary and non-limiting. The same scheme may be used in scenarios where one or more of the number of PRBs in the resource pool, the number of PSFCH occasions, or the configured value of K3 varies from what is specifically shown in FIG. 5.

It will also be understood that other variations of the interlace-first indexing scheme are also possible and contemplated by the present disclosure. For instance, in some aspects, the UE or the network node may index the PRBs in the resource pool by interlace first, but only up to the configured value of K3. For instance, if K3=5, the UE or the network node may index the first five PRBs of interlace 1 as [0, 1, 2, 3, 4], and then index the first five PRBs of interlace 2 as [5, 6, 7, 8, 9], and then index the first five PRBs of interlace 3 as [10, 11, 12, 13, 14], and so on, until the first five PRBs of interlace 5 are indexed as [20, 21, 22, 23, 24]. The indexing then continues with the last five PRBs of interlace 1 as [25, 26, 27, 28 29], and continues until the last five PRBs of interlace 5 are indexed as [45, 46, 47, 48, 49].

Based on the PSFCH resource set partitioning, the UE may transmit a PSFCH signal in the PSFCH resource set configured for the appropriate PSFCH occasion. In some aspects, the UE may receive, for each PSFCH occasion, a bitmap indicating the plurality of PRBs to be used for the PSFCH transmission in that PSFCH occasion. Thus, bitmaps corresponding to earlier or later PSFCH occasions may indicate different PRBs such that the PSFCH resource sets are cycled through for different PSFCH occasions, as illustrated in FIG. 3 above. The bitmaps may be generated such that the order of bits in the bitmap corresponds to the PRB index when indexed according to the interlace-first indexing scheme described in FIG. 5. In other aspects, the bits in the bitmaps may be ordered simply according to their frequency position within the resource pool, such as the PRB indexing shown in FIGS. 4A-4C.

FIG. 6A illustrates a pair of PSFCH resource bitmaps for a first PSFCH candidate or occasion (PSFCH candidate 0) and a second PSFCH candidate or occasion (PSFCH candidate 1). Each of the bitmaps comprises 50 bits, with each bit representing one PRB in a resource pool. Although organized as a 5×10 table, it will be understood that the bitmap may comprise a single linear sequence of 50 bits. Further, it will be understood that the bitmaps may comprise additional bits, such as header information, checksum information, PSFCH occasion index, or any other suitable or relevant information for the PSFCH resource configuration.

In FIG. 6A, the bits are ordered based on the interlace-first indexing approach explained above. Assuming five interlaces are configured for the resource pool, the 10 bits in the top row of the bitmaps correspond to the PRBs of interlace 1, the next 10 bits in the second row of the bitmaps correspond to the PRBs of interlace 2, and so on. Thus, according to the illustrated example, the first bitmap 610 indicates the sidelink UE to use the first five PRBs of interlace 1 for PSFCH candidate 0. The second bitmap 620 indicates the sidelink UE to use the first five PRBs of interlace 2 for PSFCH candidate 1. In other aspects, the second bitmap may indicate the sidelink UE to use the second five PRBs of interlace 1 for PSFCH candidate 1.

In FIG. 6B, the bits in the bitmaps are ordered based on the frequency position of the PRB within the resource pool, as shown in FIGS. 4A-4C. Thus, the bits are not grouped together by interlace, but based on their relative position within the resource pool. Accordingly, the first bitmap 610 for PSFCH candidate 0 indicates the first five PRBs of interlace 1 (every 5 PRBs), and the second bitmap 620 for PSFCH candidate 1 indicates the second five PRBs of interlace 1.

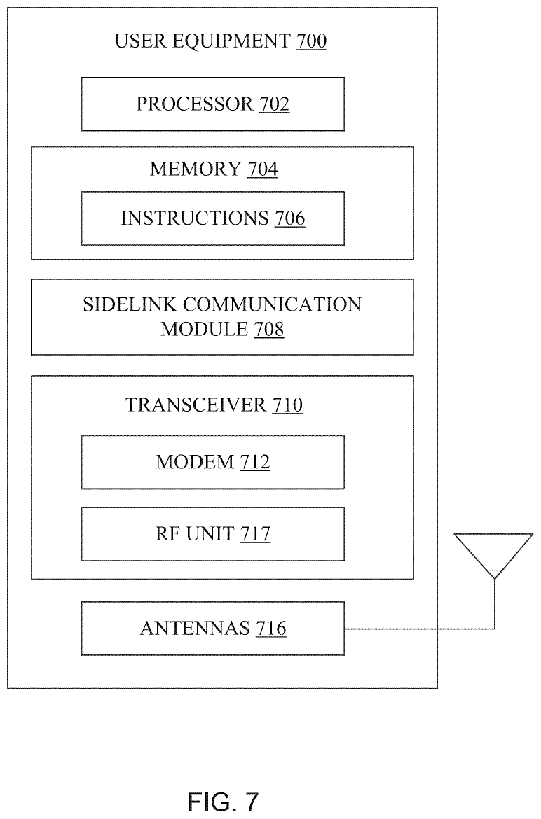

FIG. 7 is a block diagram of an exemplary UE 700 according to some aspects of the present disclosure. The UE 700 may be a UE 115 in the network 100 as discussed above in FIG. 1 or a UE 215 discussed above in FIG. 2. As shown, the UE 700 may include a processor 702, a memory 704, a sidelink communication module 708, a transceiver 710 including a modem subsystem 712 and a radio frequency (RF) unit 714, and one or more antennas 716. These elements may be in direct or indirect communication with each other, for example via one or more buses.

The processor 702 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 704 includes a non-transitory computer-readable medium. The memory 704 may store, or have recorded thereon, instructions 706. The instructions 706 may include instructions that, when executed by the processor 702, cause the processor 702 to perform the operations described herein with reference to the UEs 115 in connection with aspects of the present disclosure, for example, aspects of FIGS. 2-6B. Instructions 706 may also be referred to as program code. The program code may be for causing a wireless communication device to perform these operations, for example by causing one or more processors (such as processor 702) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 708 may be implemented via hardware, software, or combinations thereof. For example, the sidelink communication module 708 may be implemented as a processor, circuit, instructions 706 stored in the memory 704 and executed by the processor 702, or a combination thereof. In some instances, the sidelink communication module 708 can be integrated within the modem subsystem 712. For example, the sidelink communication module 708 can be implemented by a combination of software components (e.g., executed by a DSP or a general processor) and hardware components (e.g., logic gates and circuitry) within the modem subsystem 712.

The sidelink communication module 708 may be used for various aspects of the present disclosure, for example, aspects of FIGS. 2-6B. Aspects of the sidelink communication module 708 may be used by the UE 700 where the UE 700 is operating in a role where it is transmitting communications with another UE 700, and other aspects of the sidelink communication module 708 may be used by the UE 700 where the UE 700 is operating in a role where it is receiving communication from another UE 700. For example, where the UE 700 is operating in a role where it is receiving communications from another UE 700, the sidelink communication module 708 may cause the UE 700 to receive PSFCH communications with or without a common interlace, at a computed power level. In other aspects, the sidelink communication module 708 may be used to receive communications from a network unit, such as the BS 205, or the network unit 800. For instance, the sidelink communication module 708 may be used to receive PSFCH configuration information for one or more PSFCH occasions or candidates.

Sidelink communication module 708 may be configured to determine one or more PSFCH resource sets in a sidelink resource pool as explained with respect to FIG. 5. In other aspects, the sidelink communication module 708 may be configured to generate, transmit, receive, and interpret one or more PSFCH candidate bitmaps as explained with respect to FIGS. 6A and 6B.

As shown, the transceiver 710 may include the modem subsystem 712 and the RF unit 714. The transceiver 710 can be configured to communicate bi-directionally with other devices, such as the BSs 105. The modem subsystem 712 may be configured to modulate and encode the data from the memory 704, or from the sidelink communication module 708 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 714 may be configured to process (e.g., perform analog to digital conversion or digital to analog conversion, etc.) modulated/encoded data (e.g., PSFCH data, etc.) from the modem subsystem 712 (on outbound transmissions) or of transmissions originating from another source such as a UE 115 or a BS 105. The RF unit 714 may be further configured to perform analog beamforming in conjunction with the digital beamforming. Although shown as integrated together in transceiver 710, the modem subsystem 712 and the RF unit 714 may be separate devices that are coupled together at the UE 700 to enable the UE 700 to communicate with other devices.

The RF unit 714 may provide the modulated and processed data, e.g. data packets (or, more generally, data messages that may contain one or more data packets and other information), to the antennas 716 for transmission to one or more other devices. The RF unit 714 may process the modulated and processed data and generate corresponding time-domain waveforms using SC-FDMA modulation prior to transmission via the antennas 716. In other instances, the RF unit 714 may utilize OFDM modulation to generate the time-domain waveforms. The antennas 716 may further receive data messages transmitted from other devices. The antennas 716 may provide the received data messages for processing and demodulation at the transceiver 710. The transceiver 710 may provide the demodulated and decoded data (e.g., sidelink configuration, SCI, sidelink data, PSFCH, etc.) to the sidelink communication module 708 for processing. The antennas 716 may include multiple antennas of similar or different designs in order to sustain multiple transmission links. The RF unit 714 may configure the antennas 716. In some aspects, the RF unit 714 may include various RF components, such as local oscillator (LO), analog filters, mixers, or a combination thereof. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission or reception requirements at the UE 700 or an anchor UE.

In an aspect, the UE 700 can include multiple transceivers 710 implementing different RATs (e.g., NR and LTE). In an aspect, the UE 700 can include a single transceiver 710 implementing multiple RATs (e.g., NR and LTE). In an aspect, the transceiver 710 can include various components, where different combinations of components can implement different RATs.

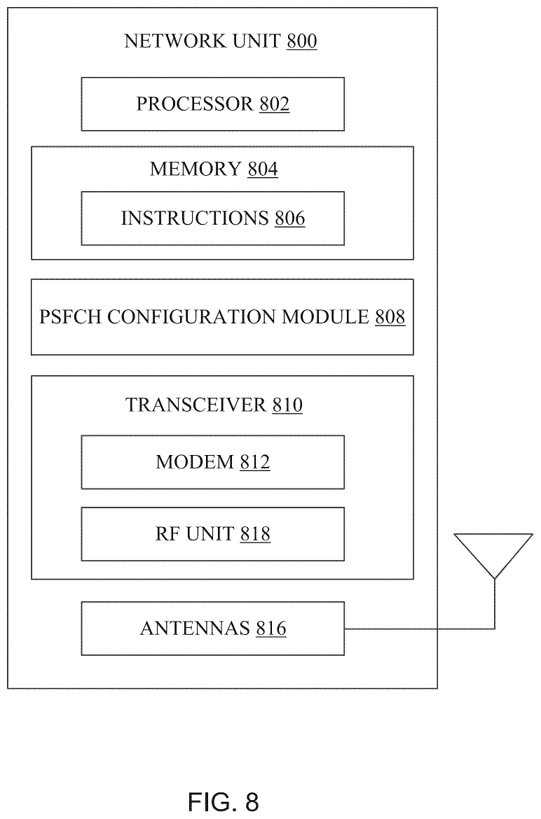

FIG. 8 is a block diagram of an exemplary Network Unit 800 (e.g., a base station, gNB, DU, CU, etc.) according to some aspects of the present disclosure. The Network Unit 800 may be a BS 105 in the network 100 as discussed above in FIG. 1 or a BS 205 discussed above in FIG. 2. As shown, the Network Unit 800 may include a processor 802, a memory 804, a PSFCH configuration module 808, a transceiver 810 including a modem subsystem 812 and a radio frequency (RF) unit 814, and one or more antennas 816. These elements may be in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 804 includes a non-transitory computer-readable medium. The memory 804 may store, or have recorded thereon, instructions 806. The instructions 806 may include instructions that, when executed by the processor 802, cause the processor 802 to perform the operations described herein with reference to the UEs 115 in connection with aspects of the present disclosure, for example, aspects of FIGS. 2-6B. Instructions 806 may also be referred to as program code. The program code may be for causing a wireless communication device to perform these operations, for example by causing one or more processors (such as processor 802) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The PSFCH configuration module 808 may be implemented via hardware, software, or combinations thereof. For example, the PSFCH configuration module 808 may be implemented as a processor, circuit, instructions 806 stored in the memory 804 and executed by the processor 802, or a combination thereof. In some instances, the PSFCH configuration module 808 can be integrated within the modem subsystem 812. For example, the PSFCH configuration module 808 can be implemented by a combination of software components (e.g., executed by a DSP or a general processor) and hardware components (e.g., logic gates and circuitry) within the modem subsystem 812.

The PSFCH configuration module 808 may be used for various aspects of the present disclosure, for example, aspects of FIGS. 2-6B. Aspects of the PSFCH configuration module 808 may be used by the Network Unit 800 where the Network Unit 800 is operating in a role where it is transmitting PSFCH configuration information to a UE for performing sidelink communications with another UE. For example, aspects of the PSFCH configuration module 808 may be used to generate and transmit PSFCH configuration bitmaps as explained with respect to FIGS. 6A and 6B. The PSFCH configuration module 808 may be configured to determine a PSFCH resource configuration using the techniques and mechanisms explained with respect to FIG. 5, for instance.

As shown, the transceiver 810 may include the modem subsystem 812 and the RF unit 814. The transceiver 810 can be configured to communicate bi-directionally with other devices, such as the BSs 105. The modem subsystem 812 may be configured to modulate and encode the data from the memory 804 and the PSFCH configuration module 808 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 814 may be configured to process (e.g., perform analog to digital conversion or digital to analog conversion, etc.) modulated/encoded data (e.g., PSFCH data, etc.) from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together at the Network Unit 800 to enable the Network Unit 800 to communicate with other devices.

The RF unit 814 may provide the modulated and processed data, e.g. data packets (or, more generally, data messages that may contain one or more data packets and other information), to the antennas 816 for transmission to one or more other devices. The RF unit 814 may process the modulated and processed data and generate corresponding time-domain waveforms using SC-FDMA modulation prior to transmission via the antennas 816. In other instances, the RF unit 814 may utilize OFDM modulation to generate the time-domain waveforms. The antennas 816 may further receive data messages transmitted from other devices. The antennas 816 may provide the received data messages for processing and demodulation at the transceiver 810. The transceiver 810 may provide the demodulated and decoded data (e.g., sidelink configuration, SCI, sidelink data, PSFCH, etc.) to the PSFCH configuration module 808 for processing. The antennas 816 may include multiple antennas of similar or different designs in order to sustain multiple transmission links. The RF unit 814 may configure the antennas 816. In some aspects, the RF unit 814 may include various RF components, such as local oscillator (LO), analog filters, mixers, or a combination thereof. The LO and the mixers can be configured based on a certain channel center frequency. The analog filters may be configured to have a certain passband depending on a channel BW. The RF components may be configured to operate at various power modes (e.g., a normal power mode, a low-power mode, power-off mode) and may be switched among the different power modes depending on transmission or reception requirements at the Network Unit 800 or an anchor UE.

In an aspect, the Network Unit 800 can include multiple transceivers 810 implementing different RATs (e.g., NR and LTE). In an aspect, the Network Unit 800 can include a single transceiver 810 implementing multiple RATs (e.g., NR and LTE). In an aspect, the transceiver 810 can include various components, where different combinations of components can implement different RATs.

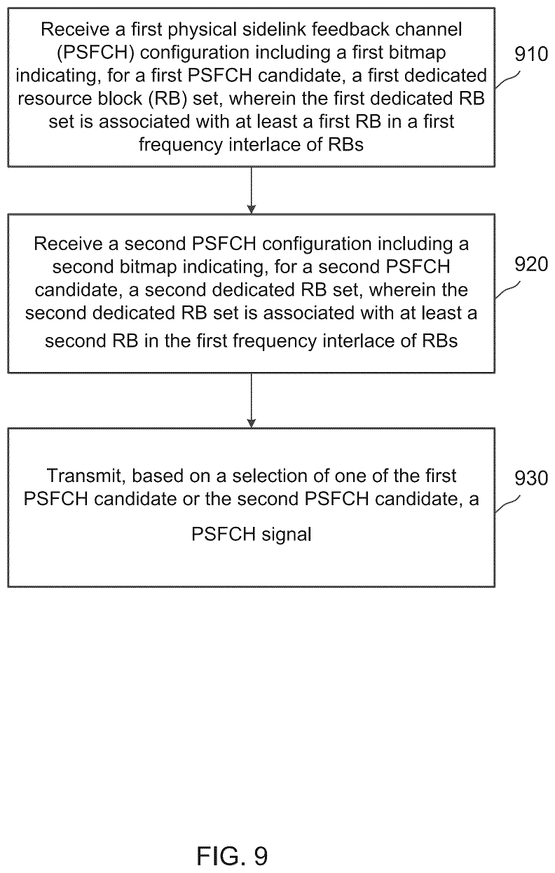

FIG. 9 is a flow diagram 900 of a method of sidelink communication according to some aspects of the present disclosure. Aspects of the method 900 can be executed by a computing device (e.g., a processor, processing circuit, or other suitable component) of a wireless communication device or other suitable means for performing the steps. For example, between two UEs such as UEs 115a and 115b, UEs 115j and 115k, UEs 215b1 and 215 b2, or 215al and 215a2, or two UE 700s. Aspects of method 900 may utilize one or more components, such as the processor 702, the memory 704, the sidelink communication module 708, the transceiver 710, the modem 712, and the one or more antennas 716, to execute the steps of method 900. As illustrated, the method 900 includes a number of enumerated steps, but aspects of the method 900 may include additional steps before, after, and in between the enumerated steps. In some aspects, one or more of the enumerated steps may be omitted or performed in a different order.

At block 910, the UE receives a first PSFCH configuration including a first bitmap. The first bitmap may indicate, for a first PSFCH candidate of a plurality of successive PSFCH candidates, a first dedicated RB set. Each PSFCH candidate of the plurality of successive PSFCH candidates may be associated with one or more of a first sidelink data transmission or a sidelink control channel transmission. In some aspects, the first PSFCH configuration may be associated with a sidelink resource pool comprising a plurality of RBs. In some aspects, the first RB set may be associated with at least one RB in a first frequency interlace of RBs, and the plurality of RBs may be associated with a plurality of interlaces, including the first frequency interlace of RBs. The first bitmap may comprise a plurality of bits, where each bit represents one RB in the sidelink resource pool. In other aspects, each bit may represent other RB-related parameters, such as an interlace index. The bits may be organized according to the interlace-first approach as in FIG. 6A, according to the PRB relative frequency position as in FIG. 6B, or any other suitable organization. In some aspects, receiving the first PSFCH configuration may comprise receiving a radio resource control (RRC) configuration or message. In other aspects, receiving the first PSFCH configuration comprises receiving control information, such as DCI, SCI, or any other suitable type of information. In some aspects, the UE receives the first PSFCH configuration from a network node or network unit, such as a BS. In other aspects, the UE receives the first PSFCH configuration from another sidelink UE.

At block 920, the UE receives a second PSFCH configuration including a second bitmap. The second bitmap may indicate, for a second PSFCH candidate, a second dedicated RB set. The second dedicated RB set may be non-overlapping in a frequency domain with the first dedicated RB set. In some aspects, the second RB set may be associated with at least a second RB in the first frequency interlace of RBs. In other aspects, the second RB set may be associated with at least one RB in a second frequency interlace of RBs. In some aspects, the second PSFCH configuration may be associated with the sidelink resource pool. The second bitmap may comprise a plurality of bits, where each bit represents one RB in the sidelink resource pool. In other aspects, each bit may represent other RB-related parameters, such as an interlace index. The bits may be organized according to the interlace-first approach as in FIG. 6A, according to the PRB relative frequency position as in FIG. 6B, or any other suitable organization. In some aspects, receiving the second PSFCH configuration may comprise receiving a RRC configuration or message. In other aspects, receiving the second PSFCH configuration comprises receiving control information, such as DCI, SCI, or any other suitable type of information. In some aspects, the UE receives the second PSFCH configuration from a network node or network unit, such as a BS. In other aspects, the UE receives the second PSFCH configuration from another sidelink UE.

At action 930, the UE transmits, based on a selection of one of the first PSFCH candidate or the second PSFCH candidate, a PSFCH signal. In some aspects, the selection of the first or second PSFCH candidate is based on a time at which the UE gains access to the sidelink resource pool. For instance, the UE may determine or select one of the PSFCH candidates based on a time at which the UE completes a LBT, or when the UE gains access to a channel occupancy time (COT). The UE may select whichever PSFCH candidate is the first available once the UE has gained access to the COT. In some aspects, the transmitting the PSFCH signal comprises transmitting sidelink ACK/NACK associated with one or more sidelink data, or control resources, such as a PSCCH or a PSSCH. In some aspects, the PSFCH comprises an interlaced PSFCH waveform occupying one of the first dedicated RB set or the second dedicated RB set. The RBs of the first and second dedicated RB sets may be associated with the same first frequency interlace of RBs. In some aspects, other UEs may be configured to use other interlaces in the same sidelink resource pool for communicating PSFCH signals.

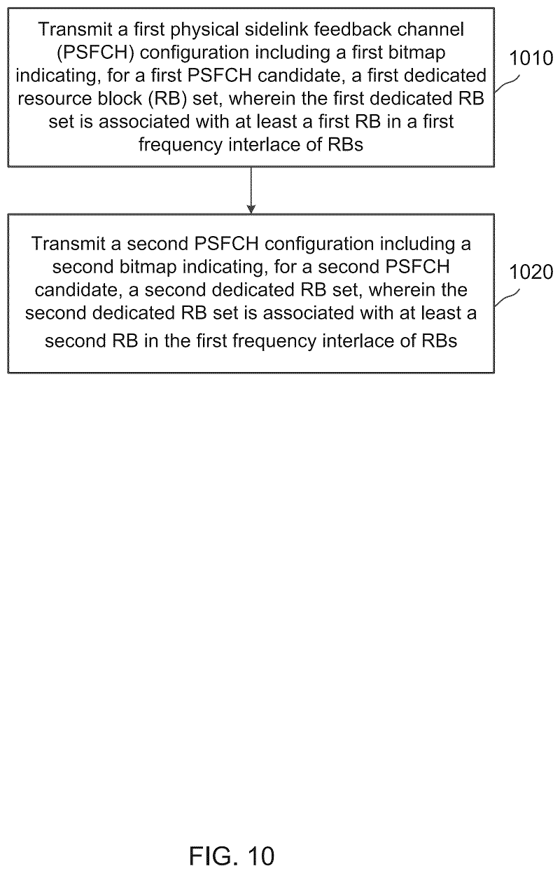

FIG. 10 is a flow diagram 1000 of a method of sidelink communication according to some aspects of the present disclosure. Aspects of the method 1000 can be executed by a computing device (e.g., a processor, processing circuit, or other suitable component) of a wireless communication device or other suitable means for performing the steps. For aspects of method 1000 may be performed by a network unit, such as a BS, DU, or CU as explained above. The network node may utilize one or more components, such as the processor 802, the memory 804, the PSFCH configuration module 808, the transceiver 810, the modem 812, and the one or more antennas 816, to execute the steps of method 1000. As illustrated, the method 1000 includes a number of enumerated steps, but aspects of the method 1000 may include additional steps before, after, and in between the enumerated steps. In some aspects, one or more of the enumerated steps may be omitted or performed in a different order.

At block 1010, the network unit transmits a first PSFCH configuration including a first bitmap. The first bitmap may indicate, for a first PSFCH candidate of a plurality of successive PSFCH candidates, a first dedicated RB set. Each PSFCH candidate of the plurality of successive PSFCH candidates may be associated with one or more of a first sidelink data transmission or a sidelink control channel transmission. In some aspects, the first PSFCH configuration may be associated with a sidelink resource pool comprising a plurality of RBs. In some aspects, the, first RB set may be associated with at least one RB in a first frequency interlace of RBs. The plurality of RBs may be associated with a plurality of interlaces, including the first frequency interlace of RBs. The first bitmap may comprise a plurality of bits, where each bit represents one RB in the sidelink resource pool. In other aspects, each bit may represent other RB-related parameters, such as an interlace index. The bits may be organized according to the interlace-first approach as in FIG. 6A, according to the PRB relative frequency position as in FIG. 6B, or any other suitable organization. In some aspects, transmitting the first PSFCH configuration may comprise transmitting a RRC configuration or message.

At block 1020, the network unit transmits a second PSFCH configuration including a second bitmap. The second bitmap may indicate, for a second PSFCH candidate, a second dedicated RB set. The second dedicated RB set may be non-overlapping in a frequency domain with the first dedicated RB set. The second RB set may be associated with at least a second RB in the first frequency interlace of RBs. In other aspects, the second RB set may be associated with at least one RB in a second frequency interlace of RBs. In some aspects, the second PSFCH configuration may be associated with the sidelink resource pool. The second bitmap may comprise a plurality of bits, where each bit represents one RB in the sidelink resource pool. In other aspects, each bit may represent other RB-related parameters, such as an interlace index. The bits may be organized according to the interlace-first approach as in FIG. 6A, according to the PRB relative frequency position as in FIG. 6B, or any other suitable organization. In some aspects, receiving the second PSFCH configuration may comprise receiving a RRC configuration or message. In other aspects, receiving the second PSFCH configuration comprises receiving control information, such as DCI, SCI or any other suitable type of information. In some aspects, the UE receives the second PSFCH configuration from a network node or network unit, such as a BS. In other aspects, the UE receives the second PSFCH configuration from another sidelink UE.

Further aspects of the present disclosure include the following:

Aspect 1. A method of wireless communication performed by a first user equipment (UE), the method comprising: receiving a first physical sidelink feedback channel (PSFCH) configuration including a first bitmap indicating, for a first PSFCH candidate, a first dedicated resource block (RB) set, wherein the first dedicated RB set is associated with at least a first RB in a first frequency interlace of RBs; receiving a second PSFCH configuration including a second bitmap indicating, for a second PSFCH candidate, a second dedicated RB set, wherein the second dedicated RB set is associated with at least a second RB in the first frequency interlace of RBs; and transmitting, based on a selection of one of the first PSFCH candidate or the second PSFCH candidate, a PSFCH signal. Aspect 1A: A method of wireless communication performed by a first user equipment (UE), the method comprising receiving a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of PSFCH candidates is associated with one or more of a first sidelink data transmission or a sidelink control channel transmission; receiving a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set; and transmitting, based on a selection of one of the first PSFCH candidate or the second PSFCH candidate, a PSFCH signal.

Aspect 2. The method of one of aspects 1 or 1A, wherein the first bitmap comprises a plurality of bits, wherein each bit of the plurality of bits indicates one RB in a PSFCH resource pool.

Aspect 3. The method of aspect 2, wherein at least a first bit of the plurality of bits is associated with the first dedicated RB set, and wherein at least a second bit of the plurality of bits is associated with the second dedicated RB set.

Aspect 4. The method of any of aspects 1, 1A, 2 or 3, wherein RBs of the first dedicated RB set are non-overlapping in the frequency domain with RBs of the second dedicated RB set.

Aspect 5. The method of any of aspects 1, 1A, 2, 3 or 4, wherein the receiving the first PSFCH configuration comprises receiving a first radio resource control (RRC) communication, and wherein the receiving the second PSFCH configuration comprises receiving a second RRC communication.

Aspect 6. The method of any of aspects 1-5, wherein: the first dedicated RB set is associated with at least a first RB in a first frequency interlace of RBs, and wherein the second dedicated RB set is associated with at least a second RB in the first frequency interlace of RBs. Aspect 6A: The method of aspect 6, wherein: the first frequency interlace of RBs comprises a first plurality of RBs indexed with a first subset of sequential indices; the second frequency interlace comprises a second plurality of RBs indexed with a second subset of sequential indices; the second subset of sequential indices is continuous with and subsequent to the first subset of sequential indices.

Aspect 7. The method of aspect 6A, wherein: the first PSFCH candidate is associated with a first plurality of sequentially-indexed RBs in the first frequency interlace of RBs; the second PSFCH candidate is associated with a second plurality of sequentially-indexed RBs in the first frequency interlace of RBs.

Aspect 8. The method of any of aspects 6, 6A or 7, wherein the first dedicated RB set is associated with a configured starting RB index within the PSFCH resource pool, and a configured number of RBs.

Aspect 9. A method of wireless communication performed by a network unit, the method comprising: transmitting a first physical sidelink feedback channel (PSFCH) configuration including a first bitmap indicating, for a first PSFCH candidate, a first dedicated resource block (RB) set, wherein the first dedicated RB set is associated with at least a first RB in a first frequency interlace of RBs; and transmitting a second PSFCH configuration including a second bitmap indicating, for a second PSFCH candidate, a second dedicated RB set, wherein the second dedicated RB set is associated with at least a second RB in the first frequency interlace of RBs. Aspect 9A: A method of wireless communication performed by a network unit, the method comprising: transmitting a first physical sidelink feedback channel (PSFCH) configuration including a first bitmap indicating, for a first PSFCH candidate of a plurality of successive PSFCH candidates in a shared frequency band, a first dedicated resource block (RB) set, wherein each PSFCH candidate of the plurality of PSFCH candidates is associated with one or more of a first sidelink data transmission or a sidelink control channel transmission; and transmitting a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set.

Aspect 10. The method of one of aspects 9 or 9A, wherein the first bitmap comprises a plurality of bits, wherein each bit of the plurality of bits indicates one RB in a PSFCH resource pool.

Aspect 11. The method of aspect 10, wherein at least a first bit of the plurality of bits is associated with the first dedicated RB set, and wherein at least a second bit of the plurality of bits is associated with the second dedicated RB set.

Aspect 12. The method of any of aspects 9, 10 or 11, wherein RBs of the first dedicated RB set are non-overlapping in the frequency domain with RBs of the second dedicated RB set.

Aspect 13. The method of any of aspects 9, 9A, 10, 11 or 12, wherein the transmitting the first PSFCH configuration comprises transmitting a first radio resource control (RRC) communication, and wherein the transmitting the second PSFCH configuration comprises transmitting a second RRC communication.

Aspect 14. The method of any of aspects 9, 9A, 10, 11, 12 or 13, wherein the first dedicated RB set is associated with at least a first RB in a first frequency interlace of RBs, and wherein the second dedicated RB set is associated with at least a second RB in the first frequency interlace of RBs. Aspect 14A: The method of any of aspect 14, further comprising: indexing a first plurality of RBs in the first frequency interlace of RBs with a first subset of sequential indices; and indexing a second plurality of RBs in a second frequency interlace with a second subset of sequential indices, wherein the second subset of sequential indices is continuous with and subsequent to the first subset of sequential indices.

Aspect 15. The method of aspect 14A, wherein the transmitting the first PSFCH configuration is based on the indexing the first plurality of RBs and the indexing the second plurality of RBs.

Aspect 16. The method of any of aspects 14, 14A or 15, wherein: the first PSFCH candidate is associated with a first plurality of sequentially-indexed RBs in the first frequency interlace of RBs; the second PSFCH candidate is associated with a second plurality of sequentially-indexed RBs in the first frequency interlace of RBs.

Aspect 17. The method of any of aspects 14, 14A, 15 or 16, wherein the first dedicated RB set is associated with a configured starting RB index within the PSFCH resource pool, and a configured number of RBs.

Aspect 18. An apparatus comprising: one or more memories; and one or more processors in communication with the one or more memories and configured to execute instructions on the one or more memories to cause the apparatus to: perform the actions of any of aspects 1, 1A, 2, 3, 4, 5, 6, 6A, 7 or 8.

Aspect 19. An apparatus comprising: one or more memories; and one or more processors in communication with the one or more memories and configured to execute instructions on the one or more memories to cause the apparatus to: perform the actions of any of aspects 9, 9A, 10, 11, 12, 13, 13A, 14, 15, 16 or 17.

Aspect 20. A non-transitory, computer-readable medium having program code recorded thereon, wherein the program code comprises instructions executable by a processor of an apparatus to cause the apparatus to: perform the actions of any of aspects 1, 1A, 2, 3, 4, 5, 6, 6A, 7 or 8.

Aspect 21. A non-transitory, computer-readable medium having program code recorded thereon, wherein the program code comprises instructions executable by a processor of an apparatus to cause the apparatus to: perform the actions of any of aspects 9, 9A, 10, 11, 12, 13, 13A, 14, 15, 16 or 17.

Aspect 22. A user equipment (UE), comprising means for performing the actions of any of aspects 1, 1A, 2, 3, 4, 5, 6, 6A, 7 or 8.

Aspect 23. A user equipment (UE), comprising means for performing the actions of any of aspects 9, 9A, 10, 11, 12, 13, 13A, 14, 15, 16 or 17.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended aspects. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the aspects, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the aspects appended hereafter and their functional equivalents.

What is aspected is:

1. A method of wireless communication performed by a first user equipment (UE), the method comprising:
receiving a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission;
receiving a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set; and
transmitting, based on a selection of one of the first PSFCH candidate or the second PSFCH candidate, a PSFCH signal.

2. The method of claim 1, wherein the first bitmap comprises a plurality of bits, wherein each bit of the plurality of bits indicates one RB in a PSFCH resource pool.

3. The method of claim 2, wherein at least a first bit of the plurality of bits is associated with the first dedicated RB set, and wherein at least a second bit of the plurality of bits is associated with the second dedicated RB set.

4. The method of claim 1, wherein the receiving the first PSFCH configuration comprises receiving a first radio resource control (RRC) communication, and wherein the receiving the second PSFCH configuration comprises receiving a second RRC communication.

5. The method of claim 1, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

6. The method of claim 5, wherein:
the first frequency interlace of RBs comprises a first plurality of RBs indexed with a first subset of sequential indices;
a second frequency interlace of RBs comprises a second plurality of RBs indexed with a second subset of sequential indices; and
the second subset of sequential indices is continuous with and subsequent to the first subset of sequential indices.

7. The method of claim 6, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

8. The method of claim 6, wherein the first dedicated RB set is associated with a configured starting RB index within a PSFCH resource pool, and a quantity of RBs.

9. A method of wireless communication performed by a network unit, the method comprising:
transmitting a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and
transmitting a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set.

10. The method of claim 9, wherein the first bitmap comprises a plurality of bits, wherein each bit of the plurality of bits indicates one RB in a PSFCH resource pool.

11. The method of claim 10, wherein at least a first bit of the plurality of bits is associated with the first dedicated RB set, and wherein at least a second bit of the plurality of bits is associated with the second dedicated RB set.

12. The method of claim 9, wherein the transmitting the first PSFCH configuration comprises transmitting a first radio resource control (RRC) communication, and wherein the transmitting the second PSFCH configuration comprises transmitting a second RRC communication.

13. The method of claim 9, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

14. The method of claim 13, further comprising:
indexing a first plurality of RBs in the first frequency interlace of RBs with a first subset of sequential indices; and
indexing a second plurality of RBs in a second frequency interlace of RBs with a second subset of sequential indices,
wherein the second subset of sequential indices is continuous with and subsequent to the first subset of sequential indices.

15. The method of claim 14, wherein the transmitting the first PSFCH configuration is based on the indexing the first plurality of RBs and the indexing the second plurality of RBs.

16. The method of claim 14, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

17. The method of claim 14, wherein the first dedicated RB set is associated with a configured starting RB index within a PSFCH resource pool, and a quantity of RBs.

18. An apparatus comprising:
one or more memories; and
one or more processors in communication with the one or more memories and configured to execute instructions on the one or more memories to cause the apparatus to:
receive a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission;
receive a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set; and
transmit, based on a selection of one of the first PSFCH candidate or the second PSFCH candidate, a PSFCH signal.

19. The apparatus of claim 18, wherein the first bitmap comprises a plurality of bits, wherein each bit of the plurality of bits indicates one RB in a PSFCH resource pool.

20. The apparatus of claim 19, wherein at least a first bit of the plurality of bits is associated with the first dedicated RB set, and wherein at least a second bit of the plurality of bits is associated with the second dedicated RB set.

21. The apparatus of claim 18, wherein the apparatus is configured to receive the first PSFCH configuration comprises the apparatus configured to receive a first radio resource control (RRC) communication, and wherein the apparatus configured to receive the second PSFCH configuration comprises the apparatus configured to receive a second RRC communication.

22. The apparatus of claim 18, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

23. The apparatus of claim 22, wherein:
the first frequency interlace of RBs comprises a first plurality of RBs indexed with a first subset of sequential indices;
a second frequency interlace of RBs comprises a second plurality of RBs indexed with a second subset of sequential indices; and
the second subset of sequential indices is continuous with and subsequent to the first subset of sequential indices.

24. The apparatus of claim 23, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

25. The apparatus of claim 23, wherein the first dedicated RB set is associated with a configured starting RB index within a PSFCH resource pool, and a quantity of RBs.

26. An apparatus comprising:
one or more memories; and
one or more processors in communication with the one or more memories and configured to execute instructions on the one or more memories to cause the apparatus to:
transmit a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and
transmit a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set.

27. The apparatus of claim 26, wherein the first bitmap comprises a plurality of bits, wherein each bit of the plurality of bits indicates one RB in a PSFCH resource pool.

28. The apparatus of claim 27, wherein at least a first bit of the plurality of bits is associated with the first dedicated RB set, and wherein at least a second bit of the plurality of bits is associated with the second dedicated RB set.

29. The apparatus of claim 26, wherein the apparatus configured to transmit the first PSFCH configuration comprises the apparatus configured to transmit a first radio resource control (RRC) communication, and wherein the apparatus configured to transmit the second PSFCH configuration comprises the apparatus configured to transmit a second RRC communication.

30. The apparatus of claim 26, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

31. The apparatus of claim 30, wherein the apparatus is further configured to:
index a first plurality of RBs in the first frequency interlace of RBs with a first subset of sequential indices; and
index a second plurality of RBs in a second frequency interlace of RBs with a second subset of sequential indices,
wherein the second subset of sequential indices is continuous with and subsequent to the first subset of sequential indices.

32. The apparatus of claim 31, wherein the apparatus configured to transmit the first PSFCH configuration is based on the indexing the first plurality of RBs and the indexing the second plurality of RBs.

33. The apparatus of claim 31, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

34. The apparatus of claim 31, wherein the first dedicated RB set is associated with a configured starting RB index within a PSFCH resource pool, and a quantity of RBs.

35. A non-transitory, computer-readable medium having program code recorded thereon, wherein the program code comprises instructions executable by a processor of an apparatus to cause the apparatus to:
receive a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission;
receive a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set; and
transmit, based on a selection of one of the first PSFCH candidate or the second PSFCH candidate, a PSFCH signal.

36. The non-transitory, computer-readable medium of claim 35, wherein the first bitmap comprises a plurality of bits, wherein each bit of the plurality of bits indicates one RB in a PSFCH resource pool.

37. The non-transitory, computer-readable medium of claim 36, wherein at least a first bit of the plurality of bits is associated with the first dedicated RB set, and wherein at least a second bit of the plurality of bits is associated with the second dedicated RB set.

38. The non-transitory, computer-readable medium of claim 35, wherein the apparatus is configured to receive the first PSFCH configuration comprises program code configured to cause the apparatus to receive a first radio resource control (RRC) communication, and wherein the program code configured to cause the apparatus to receive the second PSFCH configuration comprises program code configured to cause the apparatus to receive a second RRC communication.

39. The non-transitory, computer-readable medium of claim 35, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

40. The non-transitory, computer-readable medium of claim 39, wherein:
the first frequency interlace of RBs comprises a first plurality of RBs indexed with a first subset of sequential indices;
a second frequency interlace of RBs comprises a second plurality of RBs indexed with a second subset of sequential indices; and
the second subset of sequential indices is continuous with and subsequent to the first subset of sequential indices.

41. The non-transitory, computer-readable medium of claim 40, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

42. The non-transitory, computer-readable medium of claim 40, wherein the first dedicated RB set is associated with a configured starting RB index within a PSFCH resource pool, and a quantity of RBs.

43. A non-transitory, computer-readable medium having program code recorded thereon, wherein the program code comprises instructions executable by a processor of an apparatus to cause the apparatus to:
transmit a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and
transmit a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set.

44. The non-transitory, computer-readable medium of claim 43, wherein the first bitmap comprises a plurality of bits, wherein each bit of the plurality of bits indicates one RB in a PSFCH resource pool.

45. The non-transitory, computer-readable medium of claim 44, wherein at least a first bit of the plurality of bits is associated with the first dedicated RB set, and wherein at least a second bit of the plurality of bits is associated with the second dedicated RB set.

46. The non-transitory, computer-readable medium of claim 43, wherein the program code configured to cause the apparatus to transmit the first PSFCH configuration comprises program code configured to cause the apparatus to transmit a first radio resource control (RRC) communication, and wherein the program code configured to cause the apparatus to transmit the second PSFCH configuration comprises program code configured to cause the apparatus to transmit a second RRC communication.

47. The non-transitory, computer-readable medium of claim 43, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

48. The non-transitory, computer-readable medium of claim 47, further comprising:
indexing a first plurality of RBs in the first frequency interlace of RBs with a first subset of sequential indices; and
indexing a second plurality of RBs in a second frequency interlace of RBs with a second subset of sequential indices,
wherein the second subset of sequential indices is continuous with and subsequent to the first subset of sequential indices.

49. The non-transitory, computer-readable medium of claim 48, wherein the program code configured to cause the apparatus to transmit the first PSFCH configuration is based on the indexing the first plurality of RBs and the indexing the second plurality of RBs.

50. The non-transitory, computer-readable medium of claim 48, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

51. The non-transitory, computer-readable medium of claim 48, wherein the first dedicated RB set is associated with a configured starting RB index within a PSFCH resource pool, and a quantity of RBs.

52. A first user equipment (UE), comprising:
means for receiving a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission;
means for receiving a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set; and
means for transmitting, based on a selection of one of the first PSFCH candidate or the second PSFCH candidate, a PSFCH signal.

53. The UE of claim 52, wherein the first bitmap comprises a plurality of bits, wherein each bit of the plurality of bits indicates one RB in a PSFCH resource pool.

54. The UE of claim 53, wherein at least a first bit of the plurality of bits is associated with the first dedicated RB set, and wherein at least a second bit of the plurality of bits is associated with the second dedicated RB set.

55. The UE of claim 52, wherein the means for receiving the first PSFCH configuration comprises means for receiving a first radio resource control (RRC) communication, and wherein the means for receiving the second PSFCH configuration comprises receiving a second RRC communication.

56. The UE of claim 52, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

57. The UE of claim 56, wherein:
the first frequency interlace of RBs comprises a first plurality of RBs indexed with a first subset of sequential indices;
a second frequency interlace of RBs comprises a second plurality of RBs indexed with a second subset of sequential indices; and
the second subset of sequential indices is continuous with and subsequent to the first subset of sequential indices.

58. The UE of claim 57, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

59. The UE of claim 57, wherein the first dedicated RB set is associated with a configured starting RB index within a PSFCH resource pool, and a quantity of RBs.

60. A network unit, comprising:
means for transmitting a first physical sidelink feedback channel (PSFCH) configuration including a first bitmap indicating, for a first PSFCH candidate of a plurality of successive PSFCH candidates, a first dedicated resource block (RB) set, wherein each PSFCH candidate of the plurality of successive PSFCH candidates is associated with one or more of a first sidelink data transmission or a sidelink control channel transmission; and
means for transmitting a second PSFCH configuration including a second bitmap indicating, for a second PSFCH candidate of the plurality of successive PSFCH candidates, a second dedicated RB set, wherein the second dedicated RB set is non-overlapping in a frequency domain with the first dedicated RB set.

61. The network unit of claim 60, wherein the first bitmap comprises a plurality of bits, wherein each bit of the plurality of bits indicates one RB in a PSFCH resource pool.

62. The network unit of claim 61, wherein at least a first bit of the plurality of bits is associated with the first dedicated RB set, and wherein at least a second bit of the plurality of bits is associated with the second dedicated RB set.

63. The network unit of claim 60, wherein the means for transmitting the first PSFCH configuration comprises means for transmitting a first radio resource control (RRC) communication, and wherein the means for transmitting the second PSFCH configuration comprises means for transmitting a second RRC communication.

64. The network unit of claim 60, wherein the first RB set and the second RB set are in a shared frequency band, wherein the first dedicated RB set is associated with at least a first RB in a first frequency interlace of RBs, and wherein the second dedicated RB set is associated with at least a second RB in the first frequency interlace of RBs.

65. The network unit of claim 64, further comprising:
indexing a first plurality of RBs in the first frequency interlace of RBs with a first subset of sequential indices; and
indexing a second plurality of RBs in a second frequency interlace of RBs with a second subset of sequential indices,
wherein the second subset of sequential indices is continuous with and subsequent to the first subset of sequential indices.

66. The network unit of claim 65, wherein the transmitting the first PSFCH configuration is based on the indexing the first plurality of RBs and the indexing the second plurality of RBs.

67. The network unit of claim 65, wherein:
the first PSFCH candidate is associated with a first plurality of sequentially-indexed RBs in the first frequency interlace of RBs; and
the second PSFCH candidate is associated with a second plurality of sequentially-indexed RBs in the first frequency interlace of RBs.

68. The network unit of claim 65, wherein the first dedicated RB set is associated with a configured starting RB index within a PSFCH resource pool, and a quantity of RBs.
